(19) United States
(12) Patent Application Publication
(10) Pub. No.: US 2013/0025176 A1
(43) Pub. Date: Jan. 31, 2013

(54) SIGN HOLDER SYSTEM

(71) Applicants: Brian S. Kronemeyer, Hudsonville, MI (US); Gary A. Moshluk, Zeeland, MI (US)

(72) Inventors: Brian S. Kronemeyer, Hudsonville, MI (US); Gary A. Moshluk, Zeeland, MI (US)

(21) Appl. No.: 13/561,452

(22) Filed: Jul. 30, 2012

Related U.S. Application Data
(60) Provisional application No. 61/512,608, filed on Jul. 28, 2011.

(51) Int. Cl. G09F 15/00

(52) U.S. Cl. 40/606.01

(57) ABSTRACT

A signage system comprises polybag signage, and a sign holder system supporting the signage. The system includes a cross bar and rods that friction fit into aperture bosses on ends of the cross bar, thus creating a quick-erectable frame for supporting the signage. The cross bar is made of polymeric material such as reground glass filled polypropylene, and has a transverse cross section that is X-shaped or U-shaped for uniformity to facilitate molding and that resists undesired bending and length-wise distortion. The aperture bosses include crush ribs that facilitate easy installation but good retention of the rods. The pair of rods can be stored against sides of the cross bar in a dense storage position, and the polybag signage wrapped around the rods and cross bar for dense shipping and/or storage and/or display. The cross bar can also support an upper frame for additional signage.

This application claims benefit under 35 USC §119(e) of provisional application Ser. No. 61/512,608, filed Jul. 28, 2011, entitled SIGN HOLDER SYSTEM the entire contents of which are incorporated herein by reference.

### BACKGROUND

The present invention relates to signage systems for use in outdoor environments and configured to be held upright by being pressed into the ground, and in particular to an outdoor sign holder system providing efficient manufacture, shipping, erection, and overall functional construction.

One style of outdoor temporary signage system often used for political signs, community information signs, and customer specific signs (such as “house for sale”, “garage sale”, etc) includes a U-shaped bent wire frame with parallel linear wire segments that can be pressed into the ground, an upright bent wire portion, and a signage panel (such as a polybag with printing thereon) attached to the upright portion. For example, the polybag is designed to be pulled downwardly onto the upright bent wire portion for raised vertical support above the ground, with both sides being visible for advertising purposes.

However, bent wire frames are bulky and space consuming due to their three-dimensional U-shape, and are not easily stacked into dense arrangements for shipping and storage. Shipping of products in low numbers is particularly problematic due to their relatively large space required per unit, which large space adds considerably to shipping costs. Further, the need to match up signage panels and wire frames can be inconvenient, awkward, and inefficient, particularly when different sizes are offered for sale. Still further, sale of two separate products (i.e. the bent wire frame and the signage panels or polybags) can be frustrating, because one of the products always sells out before the other. Still further, the displays require constant maintenance, re-arrangement and care for aesthetics, and restocking.

### SUMMARY OF THE PRESENT INVENTION

In one aspect of the present invention, a signage system comprises a signage panel (which is intended to cover a polybag and/ a folded cardboard and/or a single board); and a sign holder system supporting the signage panel. The sign holder system includes a cross bar and a pair of rods, the cross bar having ends constructed to frictionally engage and hold a top of the pair of rods. The cross bar is made of polymeric material and has a transverse cross section with at least three interconnected walls extending in a parallel length direction and arranged to resist undesired bending.

In another aspect of the present invention, a method comprises steps of providing a signage panel; and providing a sign holder system for supporting the signage panel, the sign holder system including a cross bar and a pair of rods, the cross bar being made of polymeric material and having a transverse cross section with at least three interconnected walls extending in a parallel length direction and arranged to resist undesired bending. The method includes frictionally engaging a top of the pair of rods into ends of the cross bar.

In another aspect of the present invention, a method comprises steps of providing a sign holder system for supporting a signage panel, the sign holder system including a cross bar and a pair of rods, the cross bar being made of polymeric material and having a transverse cross section with at least three interconnected walls extending in a parallel length direction and arranged to resist undesired bending. The method further includes storing the pair of rods against sides of the cross bar in a dense storage position.

These and other aspects, objects, and features of the present invention will be understood and appreciated by those skilled in the art upon studying the following specification, claims, and appended drawings.

### BRIEF DESCRIPTION OF DRAWINGS

FIG. 1 is a front view of a sign system including a sign holder system and a polybag signage panel.

FIG. 2 is an exploded perspective view of FIG. 1.

FIG. 3 is a fragmentary enlarged view of the cross bar in FIG. 2.

FIG. 4 is a bottom view of FIG. 3.

FIGS. 5-6 are cross sections taken along lines V-V and VI-VI in FIG. 3.

FIG. 7 is an exploded perspective view of an alternative sign system similar to FIG. 2.

FIG. 8 is a bottom view of the cross bar in FIG. 7.

FIGS. 9-10 are cross sections taken along lines IX-IX and X-X in FIG. 8.

FIG. 11 is a front view of a modified signage system similar to FIG. 1 but including an upper sign feature.

FIG. 12 is a fragmentary view of the cross bar in FIG. 11.

### DETAILED DESCRIPTION OF PREFERRED EMBODIMENTS

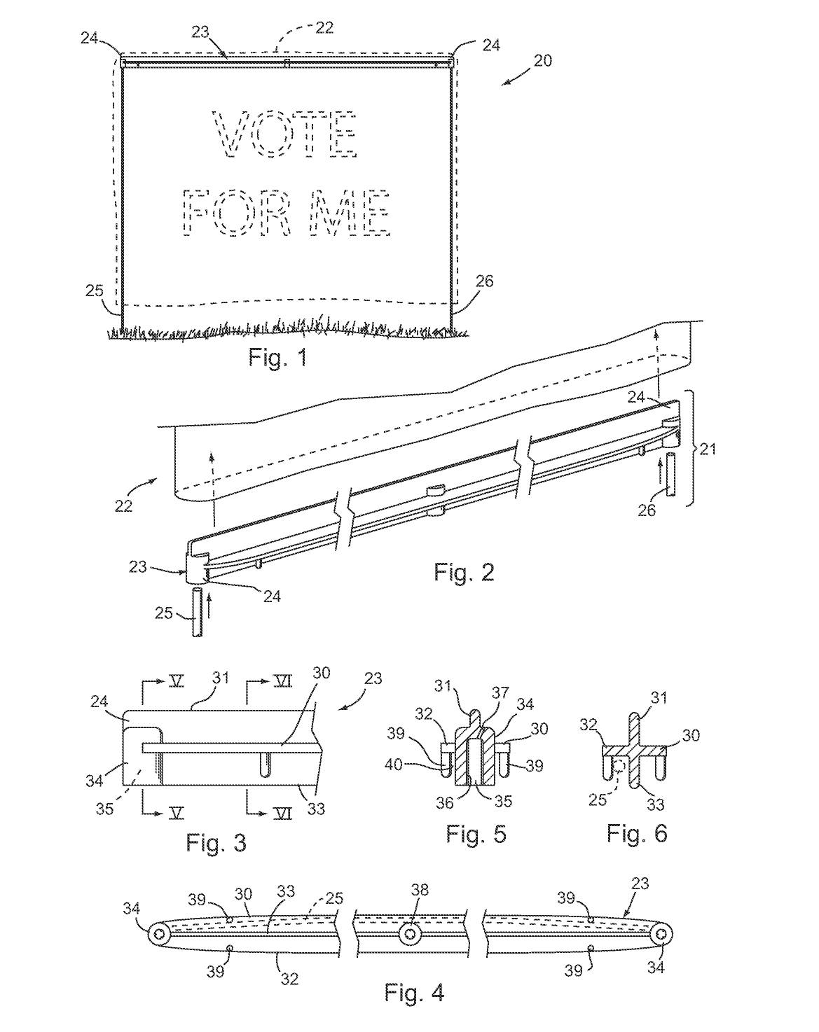

The present signage system 20 (FIG. 1) includes a sign holder system 21 and signage, such as the illustrated polybag signage panel 22 (also called “polybag signage”) supported by the sign holder system 21 for viewing above the ground. Specifically, the sign holder system 21 (FIG. 2) includes a cross bar 23 with ends 24 configured to frictionally engage and support linear wires 25, 26, (also called “metal rods”) with the wires 25, 26 pressed into the ground and with the polybag signage panel 22 pulled onto the upper portion of the sign holder system 21. The cross bar 23 is made of a structural plastic, such as reground glass-filled polypropylene. The cross bar 23 has a relatively uniform cross section well suited for fast injection molding with low distortion/bending upon cooling, and further is designed to provide an efficient, intuitive, and easy on-site construction. Still further, the cross bar 23 is designed to allow the wires 25, 26 to be stored on sides of the cross bar 23, potentially with the polybag signage panel 22 wrapped around it, in a highly dense arrangement that facilitates display, sales, shipping, storage, and overall convenience, as discussed below.

Polybag signage panels 22 are known and commercially available. As used herein, the term “signage panel” is intended to cover a polybag and/or a folded cardboard and/or a single board or other indicia displaying sheet material. A polybag is a bag constructed from sheet polymeric material that is particularly well suited to receive high quality printing of indicia 27 on its outer visible surfaces (both sides), such as a political sign or ad, community information signs, and/or customer specific signs (such as “house for sale”, “garage sale”, etc). The polybag can be made of virtually any structural plastic material (such as polyethylene, polypropylene, polystyrene) or other structural material (such as cardboard, chip board, paper sheet, card stock sheet, and the like) capable of receiving printed indicia and displaying same. Also, the illustrated polybag signage panels 22 are made of a material optimally suited for outdoor use and that is adapted to withstand outdoor elements, such as sunlight, rain, and wind. Many polybags have a blacked out inner surface so that light cannot pass through its opposing panels, thus preventing “see-through” of indicia on its back surface, which results in an improved clearer image when the signage is viewed by passing individuals.

FIG. 2 is an exploded perspective view of FIG. 1, and FIGS. 3-6 show additional features of the cross bar 23. The illustrated cross bar is made of a glass filled recycled polypropylene, but it is contemplated that alternative materials could be used. The illustrated cross bar 23 has a relatively uniform cross sectional shape, illustrated as an X-shape, which greatly facilitates its manufacture and which greatly reduces problems associated with (short term and long term) snaking, twisting, curving, creeping, and undesired bending of the long polymeric cross bar.

The illustrated cross bar 23 (FIGS. 3-6) includes four walls 30-33 forming an X-shape. The ends 24 of the cross bar 23 each include an aperture boss 34 having a cavity 35 sized to receive and frictionally engage the upper ends of the wire 25 (and wire 26). The illustrated wires 25, 26 are steel wire, cut from 9-gage wire, and have a diameter of about 0.148 inch. However, it is contemplated that alternative wire sizes and wire materials can be used, such as for example a 10 gage wire. The cavity 35 has longitudinal crush ribs 36 that provide relatively consistent frictional engagement with the wires 25 yet that reduce difficulty of insertion when in forcing the wires 25 into the cavity 35. Also, the crush ribs 36 facilitate receiving either a 9 gage or 10 gage wire in a single cross bar 23. A vent hole 37 in the closed bottom of the cavity helps vent air to further promote easy assembly. A size of the illustrated boss 34 is about 3-4 times a thickness of the walls 30-33. However, dimensional relationships can be changed to accomplish specific functional requirements without departing from the present innovative concepts. One or more additional aperture bosses 38 can be located along a length of the cross bar 23. For example, the cross bar 23 can have a length of 9″, 16″, 20″, 26″, 32″, or 36″, with the shorter lengths including zero or one additional apertured bosses 38, and with the longer lengths including one, two or even three aperture bosses 38. The opposing side walls 31 and 33 are radiused at their ends to blend into the bosses 34 and to blend in with a radiused end of the cross bar 23, which facilitates a smooth installation of and support of the polybag sign panel 22 on the sign holder 21.

A down-protruding stud 39 is molded onto an outer edge of each of the opposing walls 31 and 33 at a location about one inch (or more or less) inboard of the end-located bosses 34. This creates a space 40 between each stud 39 and the bottom wall 32. The space 40 is slightly greater than a diameter of the wire 25 (and 26). This allows the wire 25 to be placed into this space 40 in a stored position on the cross bar 23, with the wire ends held inward adjacent the center bottom wall 32. In the storage position, a middle of the wire 25 bows outward around the additional boss 38. A slight dimple (not shown) can be added to the boss 38 or stud 39 to add additional retention strength, but testing to date shows that this is not necessary. The bowing of the wire 25 is small enough so that the wire 25 does not take on a permanent bent set shape; however the bowing of the wires is sufficient to generate sufficient friction to hold the wire 25 in a retained position next to the concavity of the walls 30-33 in location space 40. FIGS. 4 and 6 only show one wire 25 held in the location space 40 on the cross bar 23, but it will be clear to a person skilled in this art that two wires 25, 26 can be held in opposing positions on the cross bar 23, one on each side of the down wall 32. It is contemplated that additional studs (not shown) could be extended from the cross bar in an opposite direction from studs 39 for storing additional wires on the cross bar.

To assemble the present apparatus in a stored position, the wires 25, 26 are stored against (including slightly bowed so that they are frictionally retained in place against) the sides of the cross bar 23, and the polybag signage panel 22 is wrapped around the subassembled wires 25, 26 and cross bar 23. The assembled units can be shipped as a dense package, individually or in groups, with the assembled units lying parallel in a box or container. All parts needed for a sign are contained in the single stored assembly. For on-site assembly, the wires 25, 26 are removed and then pressed into the end bosses 34 where they are frictionally retained, and then the assembled frame is pressed into the ground. Thereafter, the polybag signage panel 22 is pulled downwardly onto the upper portion of the frame 23, 25, 26.

Additional embodiments and features/aspects are shown using the same numbers but with the addition of a letter “A” or “B”. This is done to reduce redundant discussion. It will be clear to persons skilled in the art that many components, features, and aspects of the various embodiments are identical or similar, such that the prior discussion applies and such that the discussion need not be repeated for an understanding.

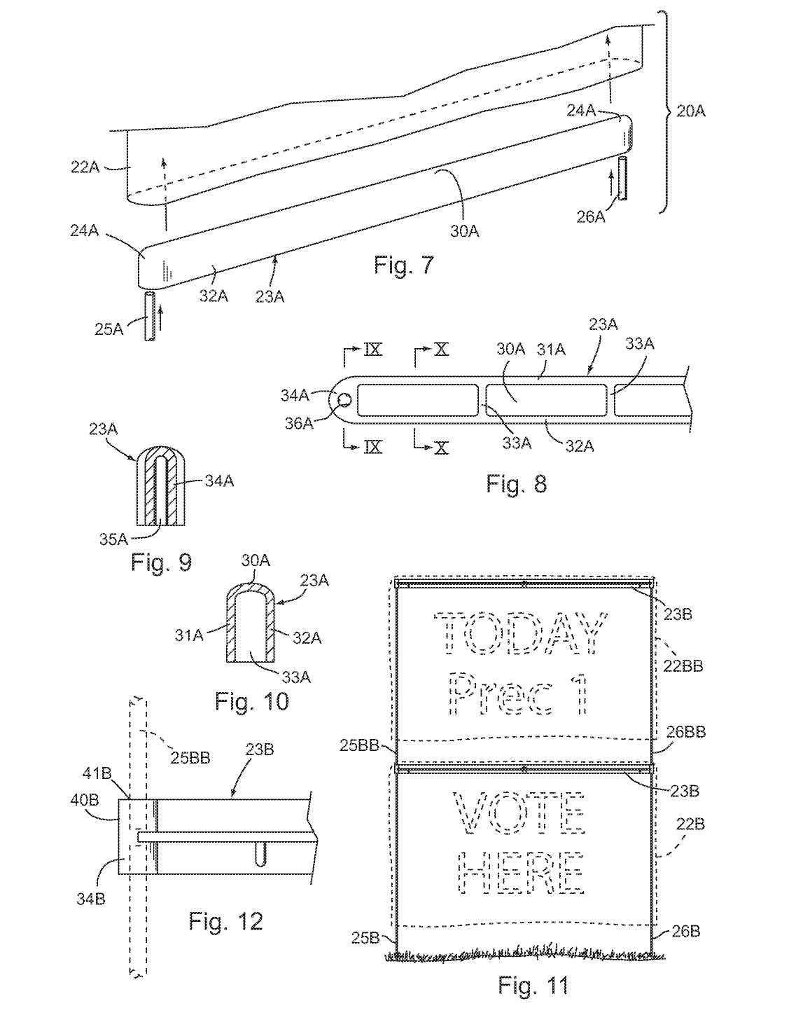

FIGS. 7-8 are an exploded perspective view and bottom view of an alternative sign system 20A similar to FIG. 2. In FIGS. 7-8, the cross bar 23A has a U-shaped cross section, with top wall 30A and side walls 31A-32A forming an internal cavity opening downward. Cross ribs 33A extend transversely between walls 31A-32A. End bosses 34A are formed at each end of the cross bar 23A, and are shaped to receive and frictionally engage the ends of the metal wires 25A, 26A. FIGS. 9-10 are cross sections taken along lines IX-IX and X-X in FIG. 8, and show relative dimensional relationships, but it is noted that the cross sectional dimensions can be modified to satisfy various functional requirements of specific applications while still staying within the bounds of the present innovative concepts.

FIG. 11 is a front view of a modified signage system 20B similar to FIG. 1 but including an upper sign feature. Specifically, the cross bar 23B is identical to cross bar 23, but is modified to include a boss extension 40B above each of the end bosses 34B. By this arrangement, a metal rod 25BB can be extended into the upwardly-open aperture 41B (FIG. 12) of the boss extension 40B, thus creating a goal-post-like arrangement of two parallel upper metal wires 25BB, 26BB. A second cross bar 23B (or 23) can be attached to a top of the upper metal wires, thus creating an upper frame, onto which a polybag signage 22BB can be attached (FIG. 11). It is conceived that studs 39B can be extended to retain the four metal wires 25B, 25BB, 26B, 26BB to the cross bar 23B, two metal wires being stored on each side. The boss extension 40B forms an upper mount that can be used to support many different items, and hence its use and structure should not be limited to only upper signage nor only support of a vertical linear upper wire. In a broadest sense, the boss extension could be a stud or other mounting structure.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A signage system comprising:
a signage panel; and
a sign holder system supporting the signage panel, the sign holder system including a cross bar and a pair of rods, the cross bar having ends constructed to frictionally engage and hold a top of the pair of rods, the cross bar being made of polymeric material and having a transverse cross section with at least three interconnected walls extending in a parallel length direction and arranged to resist undesired bending.

2. The signage system defined in claim 1, wherein the cross section is X-shaped formed by the at least three interconnected walls.

3. The signage system defined in claim 1, wherein the cross section is U-shaped formed by the at least three interconnected walls.

4. The signage system defined in claim 1, wherein the ends each have an apertured boss.

5. The signage system defined in claim 4, wherein the apertured bosses include internal crush ribs.

6. The signage system defined in claim 4, wherein the apertured bosses include a hole with a closed bottom and a vent hole in the closed bottom.

7. The signage system defined in claim 1, wherein the material of the cross bar is a glass filled polymer.

8. The signage system defined in claim 1, wherein the material of the cross bar includes a reground polymer.

9. The signage system defined in claim 1, wherein the cross bar includes at least one retaining member for retaining the rods against a side of the cross bar.

10. The signage system defined in claim 9, wherein the at least one retaining member includes at least one transversely extending stud that extends from one of the walls.

11. The signage system defined in claim 10, wherein the at least one transversely extending stud includes a pair of studs that extend from one of the walls, one near each end of the cross bar.

12. The signage system defined in claim 1, wherein the ends of the cross bar each include an aperture boss forming both a downwardly open hole and an upwardly open hole, both shaped to engage one of the rods.

13. A method comprising steps of:
providing a signage panel;
providing a sign holder system for supporting the signage panel, the sign holder system including a cross bar and a pair of rods, the cross bar being made of polymeric material and having a transverse cross section with at least three interconnected walls extending in a parallel length direction and arranged to resist undesired bending; and
frictionally engaging a top of the pair of rods into ends of the cross bar.

14. A method comprising steps of:
providing a sign holder system for supporting a signage panel, the sign holder system including a cross bar and a pair of rods, the cross bar being made of polymeric material and having a transverse cross section with at least three interconnected walls extending in a parallel length direction and arranged to resist undesired bending; and
storing the pair of rods against sides of the cross bar in a dense storage position.

15. The method defined in claim 14, including wrapping a signage panel around the cross bar with the rods inside of the signage panel to create a dense storage system including the sign holder system and the signage panel.

16. The method defined in claim 15, wherein the signage panel comprises a polybag with indicia printed on visible sides of the polybag.
